(19) United States
(12) Patent Application Publication
(10) Pub. No.: US 2007/0170835 A1
(43) Pub. Date: Jul. 26, 2007

(54) FLAT FLUORESCENT LAMP, METHOD OF MANUFACTURING THE SAME, AND DISPLAY APPARATUS HAVING THE SAME 111

(75) Inventors: Don-Chan Cho, Seongnam-si (KR); Hae-Il Park, Seoul (KR); Jin-Seob Byun, Seoul (KR); Sang-Yu Lee, Yongin-si (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/538,397

(22) Filed: Oct. 3, 2006

(30) Foreign Application Priority Data
Jan. 26, 2006 (KR) 2006-8484

(51) Int. Cl. H01J 1/62; H01J 63/04

(52) U.S. Cl. 313/493

(57) ABSTRACT

A flat fluorescent lamp includes a first substrate, a second substrate, a first fluorescent layer, a second fluorescent layer, a combining member and a contacting layer. The second substrate is combined with the first substrate to form a plurality of discharge chambers spaced apart from each other. The first fluorescent layer is formed on an inner surface of the first substrate, and the second fluorescent layer is formed on an inner surface of the second substrate. The combining member is disposed between the first substrate and the second substrate. The contacting layer is formed between the discharge chambers. Thus, mercury vapor in a flat fluorescent lamp may be prevented from migrating due to a temperature difference between discharge chambers, and luminescence characteristics of a flat fluorescent lamp may be improved.

### CROSS-REFERENCE TO RELATED APPLICATIONS

This application relies for priority upon Patent Application No. 2006-8484 filed in the Korean Intellectual Property Office, Republic of Korea, on Jan. 26, 2006, the entire content of which is herein incorporated by reference.

### BACKGROUND OF THE INVENTION

1. Field of the Invention

The present invention relates to a flat fluorescent lamp, a method of manufacturing the flat fluorescent lamp, and a display apparatus having the flat fluorescent lamp. More particularly, the present invention relates to a flat fluorescent lamp capable of preventing mercury vapor from migrating, to improve luminescence characteristics, a method of manufacturing the flat fluorescent lamp and a display apparatus having the flat fluorescent lamp.

2. Description of the Related Art

In general, a liquid crystal display (LCD) apparatus requires a backlight assembly since its display panel is not self-emissive. Recently, as the LCD apparatus has increased in size, a flat fluorescent lamp has been developed in order to reduce manufacturing costs and to improve ease of assembly. A flat fluorescent lamp includes a plurality of discharge chambers formed between a lower substrate and an upper substrate. A reflective layer and a fluorescent layer are formed on inner surfaces of the lower substrate and the upper substrate, respectively. The upper substrate is combined with the lower substrate by means of a combining member such as frit, etc. The combining member is disposed in a peripheral area of each of the lower substrate and the upper substrate. Portions of the lower substrate and the upper substrate, which are disposed between the discharge chambers, make contact with each other by a pressure difference between the interior of the flat fluorescent lamp and the exterior of the flat fluorescent lamp.

In such a flat fluorescent lamp, a gap may be formed between the discharge chambers due to the roughness of the fluorescent layer and/or a difference between a thickness of the combining member and a sum of thicknesses of the reflective layer and the fluorescent layer. Thus, a temperature difference between the discharge chambers may cause mercury vapor to migrate through the gap so that luminescence characteristics of the flat fluorescent lamp are degraded.

### SUMMARY OF THE INVENTION

One or more embodiments of the present invention provide a flat fluorescent lamp capable of preventing mercury vapor from migrating, to improve luminescence characteristics. The present invention also provides a method of manufacturing the above-mentioned flat fluorescent lamp. The present invention also provides a display apparatus having the above-mentioned flat fluorescent lamp.

According to one embodiment of the present invention, a flat fluorescent lamp includes a first substrate, a second substrate, a first fluorescent layer, a second fluorescent layer, a combining member and a contacting layer. The second substrate is combined with the first substrate to form a plurality of discharge chambers spaced apart from each other. The first fluorescent layer is formed on an inner surface of the first substrate, and the second fluorescent layer is formed on an inner surface of the second substrate. The combining member is disposed between the first substrate and the second substrate to combine the first substrate with the second substrate. The contacting layer is formed between the discharge chambers. The second substrate may include a plurality of discharge portions spaced apart from the first substrate to form the discharge spaces, a plurality of non-discharge portions making contact with the contacting layer, and a sealing portion that is disposed in a peripheral area of the second substrate and is combined with the first substrate. Each of the non-discharge portions may be disposed between the discharge portions. The combining member may correspond to the sealing portion.

The flat fluorescent lamp may further include a reflective layer formed between the first substrate and the first fluorescent layer. A sum of thicknesses of the reflective layer, the first fluorescent layer, the second fluorescent layer and the contacting layer may be substantially equal to a thickness of the combining member. The flat fluorescent lamp may further include a reflective layer formed on an inner surface of the substrate, a first protective layer formed between the reflective layer and the first fluorescent layer and a second protective layer formed between the second substrate and the second fluorescent layer. A sum of thicknesses of the reflective layer, the first protective layer, the first fluorescent layer, the second protective layer, the second fluorescent layer and the contacting layer is substantially equal to a thickness of the combining member.

In accordance with another embodiment of the present invention, there is provided a method of manufacturing a flat fluorescent lamp. In the method, a reflective layer and a first fluorescent layer are sequentially formed on an inner surface of a first substrate. A second substrate is formed to be combined with the first substrate to form a plurality of discharge chambers spaced apart from each other. A second fluorescent layer is formed on an inner surface of the second substrate. A contacting layer is formed on one of the first fluorescent layer and the second fluorescent layer. The contacting layer is disposed between the discharge spaces. The first substrate is combined with the second substrate.

In accordance with another embodiment of the present invention, a display apparatus includes a flat fluorescent lamp configured to generate light and a display unit operatively coupled to the flat fluorescent lamp and configured to display an image by using the generated light. The flat fluorescent lamp includes a first substrate having a reflective layer and a first fluorescent layer, a second substrate that has a second fluorescent layer and is combined with the first substrate to form a plurality of discharge chambers spaced apart from each other, a combining member disposed between the first substrate and the second substrate to combine the first substrate with the second substrate, and a contacting layer formed between the first substrate and the second substrate and between the discharge chambers, such that a sum of thicknesses of the reflective layer, the first fluorescent layer, the second fluorescent layer and the contacting layer is substantially equal to a thickness of the combining member.

According to one or more of the above embodiments, mercury vapor in a flat fluorescent lamp may be prevented from migrating due to a temperature difference between discharge chambers, and luminescence characteristics of a flat fluorescent lamp may be improved.

### BRIEF DESCRIPTION OF THE DRAWINGS

The above and other advantages of the present invention will become readily apparent by reference to the following detailed description when considered in conjunction with the accompanying drawings, wherein:

FIG. 1 is a perspective view illustrating an exemplary flat fluorescent lamp, according to an embodiment of the present invention;

FIG. 2 is an exploded perspective view illustrating the flat fluorescent lamp illustrated in FIG. 1;

FIG. 3 is a cross-sectional view taken along a line I-I′ shown in FIG. 1;

FIG. 4 is a cross-sectional view taken along a line II-II′ shown in FIG. 1;

FIG. 5 is a cross-sectional view taken along a line III-III′ shown in FIG. 1;

FIG. 6 is a cross-sectional view illustrating an exemplary flat fluorescent lamp, according to an embodiment of the present invention;

FIGS. 7 to 9 are cross-sectional views and a perspective view, which illustrate an exemplary method of manufacturing a flat fluorescent lamp, according to an embodiment of the present invention; and

FIG. 10 is an exploded perspective view illustrating an exemplary display apparatus, according to an embodiment of the present invention.

### DETAILED DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any, and all, combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

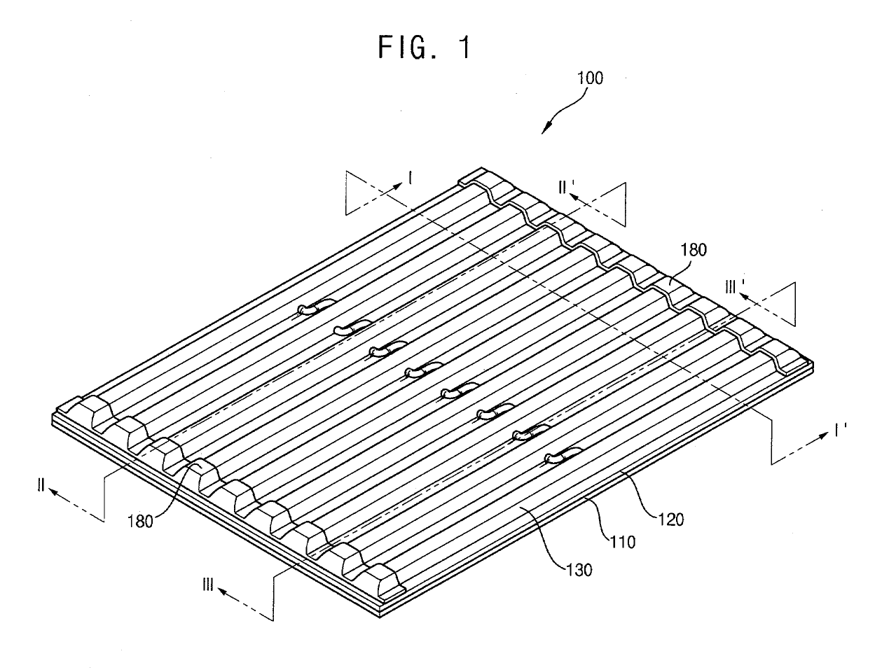

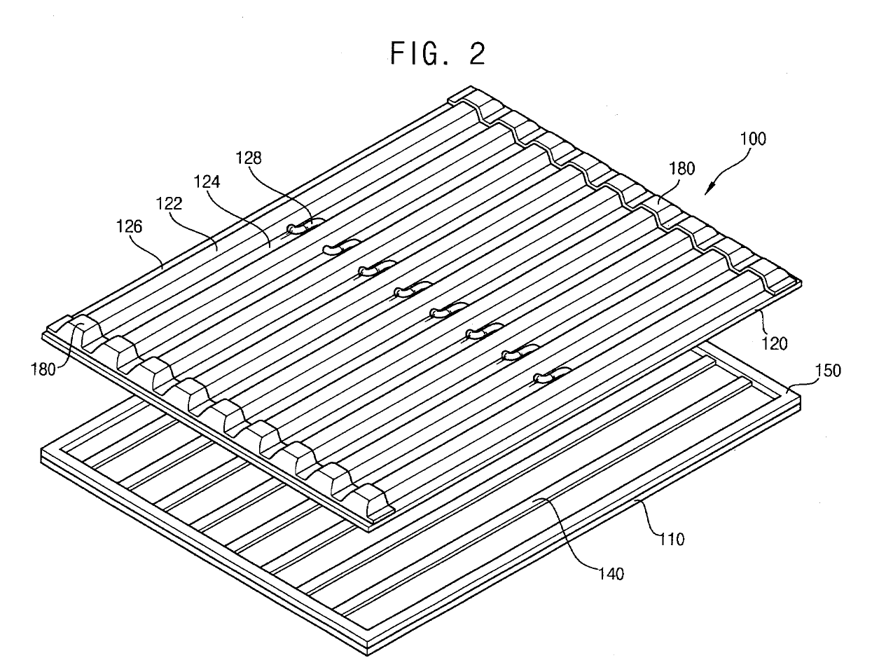

FIG. 1 is a perspective view illustrating an exemplary flat fluorescent lamp, according to an embodiment of the present invention. FIG. 2 is an exploded perspective view illustrating the flat fluorescent lamp illustrated in FIG. 1. Referring to FIGS. 1 and 2, a flat fluorescent lamp 100 includes a first substrate 110, a second substrate 120 combined with the first substrate 110, and a contacting layer 140 formed between the first substrate 110 and the second substrate 120. The flat fluorescent lamp 100 includes the discharge spaces or chambers 130 to generate light. In order to emit a planar or surface-shaped light, the flat fluorescent lamp 100 has a quadrangular shape when viewed from a plan view. The flat fluorescent lamp 100 generates a plasma discharge in the discharge chambers 130 in response to a driving voltage applied to the flat fluorescent lamp 100 from an external inverter. Ultraviolet (UV) light generated by the plasma discharge is converted to visible light, and the visible light exits from the flat fluorescent lamp 100. The flat fluorescent lamp 100 includes the discharge chambers 130 in order to increase luminous efficiency and to emit uniform light.

The first substrate 110 has the shape of a quadrangular plate. The first substrate 110 may include soda-lime glass and a material for blocking UV light to prevent the UV light generated by the plasma discharge from leaking. The second substrate 120 is combined with the first substrate 110 to form the discharge chambers 130 spaced apart from each other by a predetermined distance. The second substrate 120 may also include soda-lime glass and a material for blocking UV light to prevent the UV light generated by the plasma discharge from leaking. The second substrate 120 has a predetermined shape in order to form the discharge chambers 130. For example, a glass plate is heated at a temperature higher than a softening point and is molded into the second substrate having a desired shape. The softening point represents a temperature at which glass deforms under its own weight. For example, the softening point of soda-lime glass is about 727° C. Alternatively, a glass plate may be heated at a temperature higher than a softening point, and compressed air may be applied to the heated glass plate to form the second substrate 120 having a desired shape.

The second substrate 120 includes a plurality of discharge portions 122, a plurality of non-discharge portions 124 and a sealing portion 126 to form the discharge chambers 130. The discharge portions 122 are spaced apart from the first substrate 110 to form the discharge chambers 130. The non-discharge portions 124 make contact with the first substrate 110 to separate the discharge chambers 130 from each other. The sealing portion 126 is combined with the first substrate 110 in a peripheral area of the second substrate 120. The first substrate 110 is combined with the second substrate 120 to form the discharge chambers 130. The discharge chambers 130 are spaced apart from each other by the non-discharge portions 124. For example, a width of each of the discharge portions 122 may be about 10 mm, and a width of each of the non-discharge portions 124 may be about 4 mm.

The second substrate 120 has an exhaust portion 128 to connect the discharge chambers 130 to each other. A plurality of the exhaust portions 128 may be formed at each of the non-discharge portions 124. The exhaust portion 128 exhausts air in the discharge chambers 130. Furthermore, the exhaust portion 128 serves as a passage through which air or a discharge gas passes when a discharge gas is injected into the discharge chambers 130. The exhaust portion 128 may be formed with the second substrate 120. The exhaust portion 128 may have various shapes, such that the exhaust portion 128 connects the discharge chambers 130 to each other. For example, the exhaust portion 128 may have a bending “S” shape. The exhaust portion 128 having a bending “S” shape increases a distance, by which a discharge gas moves, to prevent the discharge gas from drifting due to interference among the discharge chambers 130 adjacent to each other.

The flat fluorescent lamp 100 further includes a combining member 150 to combine the first substrate 110 with the second substrate 120. For example, the combining member 150 may include frit that is a mixture of a metal and a glass having a melting point lower than a melting point of pure glass. The combining member 150 is disposed between the first substrate 110 and the second substrate 120, to correspond to, or align with, a sealing portion 126. The combining member 150 disposed between the first substrate 110 and the second substrate 120 is melted by an externally provided heat and is cooled to combine the first substrate 110 with the second substrate 120. The above-mentioned combining process may be performed at temperatures between about 400 to about 600° C. The non-discharge portions 124 except for the sealing portion 126 make contact with the first substrate 110 by a pressure difference between the interior of the flat fluorescent lamp 100 and the exterior of the flat fluorescent lamp 100.

Particularly, after the first substrate 110 is combined with the second substrate 120, air in the discharge chambers 130 is exhausted so that a vacuum is formed in the discharge chambers 130. Thereafter, a discharge gas is injected into the discharge chambers 130. Examples of the discharge gas may include mercury, neon, argon, etc. The discharge gas in the discharge chambers 130 has a gas pressure of about 50 to about 70 Torr while an atmospheric pressure of the exterior of the flat fluorescent lamp 100 may be about 760 Torr. The difference between the gas pressure in the discharge chambers 130 and the atmospheric pressure applies a force from the exterior to the interior of the flat fluorescent lamp 100, so that the non-discharge portions 124 make contact with the first substrate 110.

When the first substrate 110 is combined with the second substrate 120 by the combining member 150, a gap may be formed between the non-discharge portion 124 and the first substrate 110. Thus, mercury vapor may move through the gap. Thus, the flat fluorescent lamp 100 further includes a contacting layer 140 to prevent mercury vapor from migrating. The contacting layer 140 is formed between the first substrate 110 and the second substrate 120 and between the discharge chambers 130. In detail, the contacting layer 140 corresponds to, or aligns with, the non-discharge portion 124. Thus, the contacting layer 140 is sandwiched between the non-discharge portion 124 and the first substrate 110.

The flat fluorescent lamp 100 further includes an external electrode 180 to apply a discharging voltage to each of the discharge chambers 130. The external electrode 180 is formed at an outer surface of at least one of the first substrate 110 and the second substrate 120. The external electrode 180 is formed at an end portion of the discharge chamber 130. The external electrode 180 crosses the discharge chambers 130 to apply a discharging voltage to each of the discharge chambers 130. The external electrode 180 formed at the first substrate 110 may be electrically connected to the external electrode 180 formed at the second substrate 120 through a connecting member such as a conducting clip (not shown). The external electrode 180 includes a conducting material to receive a discharging voltage from an external inverter. Examples of the external electrode 180 include a silver paste that is a mixture of silver and silicon oxide (SiO₂), a metal, a mixture of metal, etc. The external electrode 180 may be formed through a spray-on method, a spin-coating method, a dipping method, etc. Furthermore, the external electrode 180 may be formed using a metal socket.

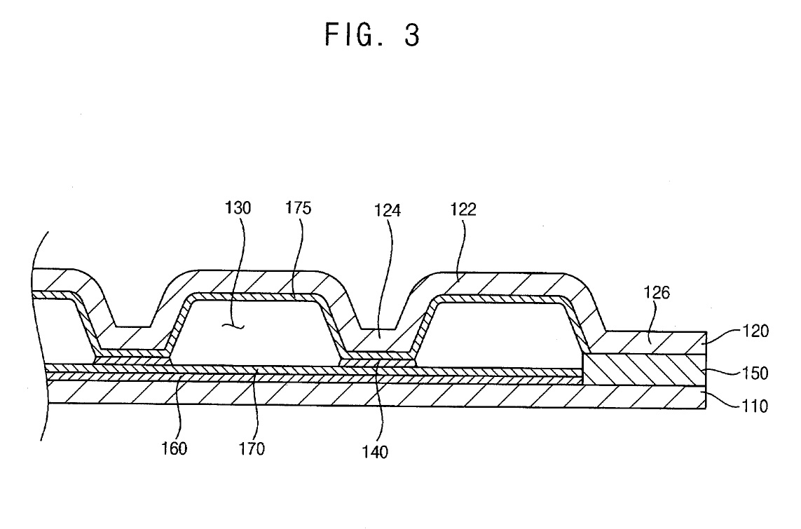

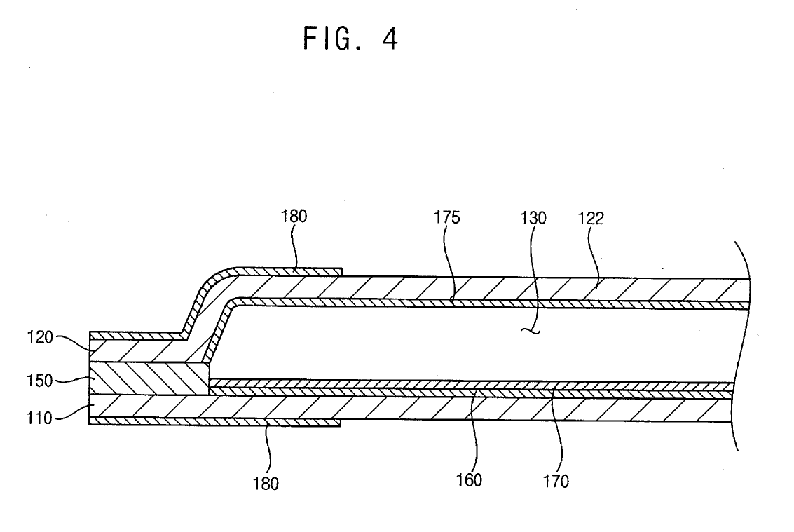

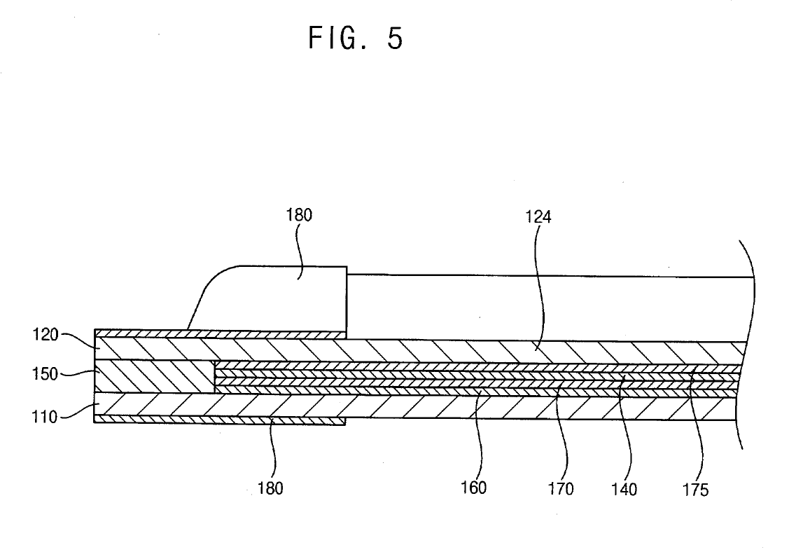

FIG. 3 is a cross-sectional view taken along a line I-I′ shown in FIG. 1. FIG. 4 is a cross-sectional view taken along a line II-II′ shown in FIG. 1. FIG. 5 is a cross-sectional view taken along a line III-III′ shown in FIG. 1. Referring to FIGS. 3 to 5, the flat fluorescent lamp 100 further includes a reflective layer 160 formed on an inner surface of the first substrate 110, which faces the second substrate 120, and a first fluorescent layer 170. Furthermore, the flat fluorescent lamp 100 further includes a second fluorescent layer 175 formed on an inner surface of the second substrate 120, which faces the first substrate 110. The first and the second fluorescent layers 170 and 175 are excited by UV light generated by a plasma discharge to emit visible light. The reflective layer 160 reflects the visible light to prevent the visible light from leaking through the first substrate 110. For example, the reflective layer 160 may include aluminum oxide (Al₂O₃). Combining member 150 may have a thickness from about 180 μm (micrometers) to about 200 μm, reflective layer 160 may have a thickness of about 80 μm, first fluorescent layer 170 may have a thickness of about 40 μm, and second fluorescent layer 175 may have a thickness of about 15 μm. Thus, an arithmetic sum of the thicknesses of the reflective layer 160, the first and the second fluorescent layers 170 and 175 may be about 135 μm to about 140 μm. Therefore, a difference between the thickness of the combining member 150 and the sum of the thicknesses of the reflective layer 160, the first fluorescent layer 170, and the second fluorescent layer 175 may be from about 60 μm to about 70 μm.

A contacting layer 140 is formed between the first substrate 110 and the second substrate 120, to correspond to the non-discharge portion 124. A thickness of the contacting layer 140 corresponds to the difference between the thickness of the combining member 150 and the sum of the thicknesses of the reflective layer 160, the first fluorescent layer 170, and the second fluorescent layer 175. More particularly, the thickness of the contacting layer 140 may be from about 60 μm to about 70 μm.

The sum of the thicknesses of the reflective layer 160, the contacting layer 140, the first fluorescent layer 170, and the second fluorescent layer 175 is substantially equal to the thickness of the combining member 150. Thus, a potential gap formed between the discharge chambers 130 is sealed so that mercury vapor is prevented from migrating. The first and the second fluorescent layers 170 and 175 include relatively large or coarse particles. Thus, a gap may be formed between the first and the second fluorescent layers 170 and 175, which make contact with each other. The contacting layer 140 may include relatively small or fine particles in comparison to particles of the first and the second fluorescent layers 170 and 175, to seal a potential gap formed between the first and the second fluorescent layers 170 and 175 at their region of closest contact. Examples of the contacting layer 140 may include yttrium oxide (Y₂O₃), aluminum oxide (Al₂O₃), etc. Since yttrium oxide (Y₂O₃) and/or aluminum oxide (Al₂O₃) is used for a reflective layer or a protective layer of a flat fluorescent lamp, an incongruity between the contacting layer 140 and the fluorescent layers 170 and 175 may be reduced. Since an edge portion of the contacting layer 140 is exposed to the discharge chamber 130, it is not preferable that the contacting layer 140 should include an organic material.

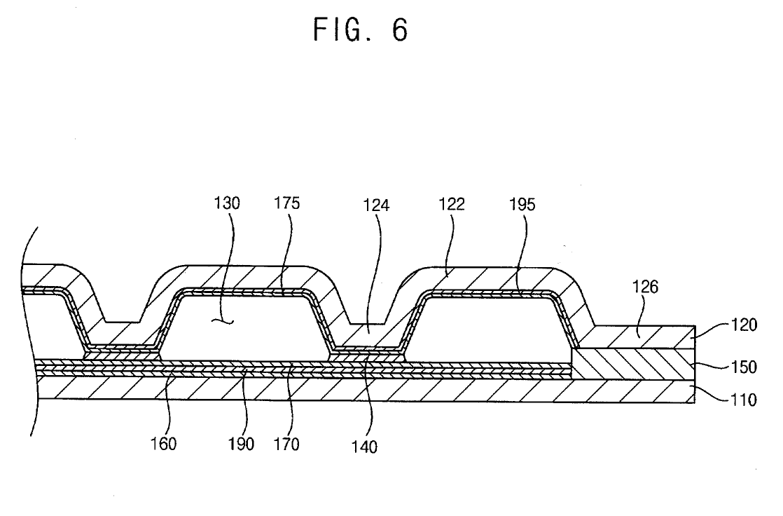

FIG. 6 is a cross-sectional view illustrating an exemplary flat fluorescent lamp, according to an embodiment of the present invention. The flat fluorescent lamp illustrated in FIG. 6 is substantially the same as the flat fluorescent lamp illustrated in FIG. 3 except for a first protective layer and a second protective layer. Thus, any further description will be omitted. Referring to FIG. 6, a flat fluorescent lamp 100 further includes a first protective layer 190 formed between a reflective layer 160 and a first fluorescent layer 170 and a second protective layer 195 formed between a second substrate 120 and a second fluorescent layer 175. The first and the second protective layers 190 and 195 prevent mercury vapor in a discharge chamber 130 from penetrating into the substrates 110 and 120 and chemically reacting with the substrates 110 and 120 to prevent loss of mercury vapor and blackening of the substrates 110 and 120. For example, the first and the second protective layers 190 and 195 may include yttrium oxide (Y₂O₃), and a thickness of each of the first and the second protective layers 190 and 195 may be from about 1 μm to about 2 μm.

A thickness of the contacting layer 140 corresponds to a difference between a thickness of the combining member 150 and a sum of thicknesses of the reflective layer 160, the first protective layer 190, the first fluorescent layer 170, the second protective layer 195 and the second fluorescent layer 175. More particularly, the thickness of the contacting layer 140 may be from about 60 μm to about 70 μm. The sum of the thicknesses of the reflective layer 160, the contacting layer 140, the first protective layer 190, the first fluorescent layer 170, the second protective layer 195 and the second fluorescent layer 175 is substantially the same as the thickness of the combining member 150 to prevent mercury vapor from migrating between discharge chambers 130.

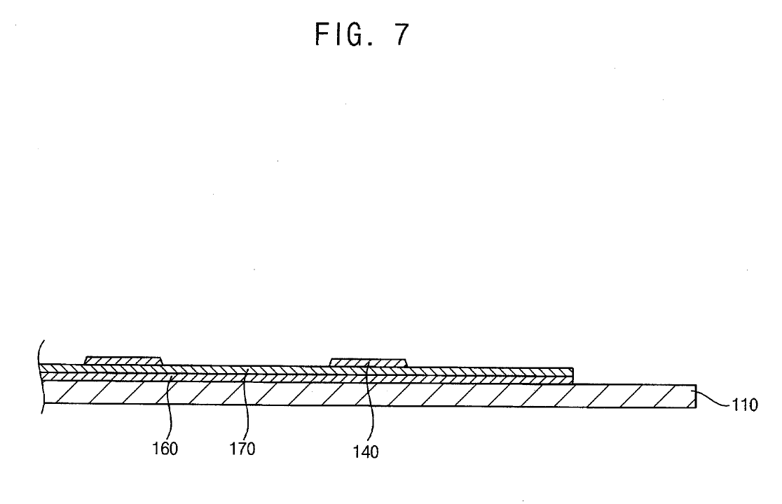

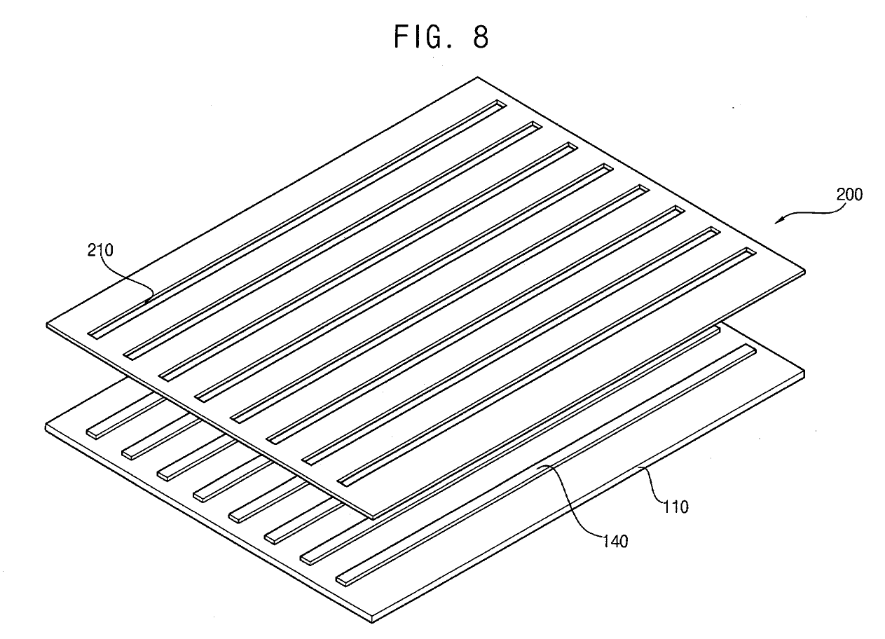

FIGS. 7 to 9 are cross-sectional views and a perspective view, which illustrate an exemplary method of manufacturing a flat fluorescent lamp, according to an embodiment of the present invention. Referring to FIG. 7, a reflective layer 160 and a first fluorescent layer 170 are sequentially formed on a first substrate 110 including a transparent glass. For example, a thickness of the reflective layer 160 is about 80 μm, and a thickness of the first fluorescent layer 170 is about 40 μm. Referring to FIG. 8, a mask 200 is disposed on the first substrate 110 having the reflective layer 160 and the first florescent layer 170, and a contacting layer 140 is formed on the first florescent layer 170. The mask 200 has an opening 210 that corresponds to a non-discharge portion. More particularly, after the mask is 200 disposed on the first substrate 110, a layer-forming material is coated on the first substrate 110 through the opening 210 to form the contacting layer 140. The contacting layer 140 may be formed on a second fluorescent layer 175 of a second substrate 120.

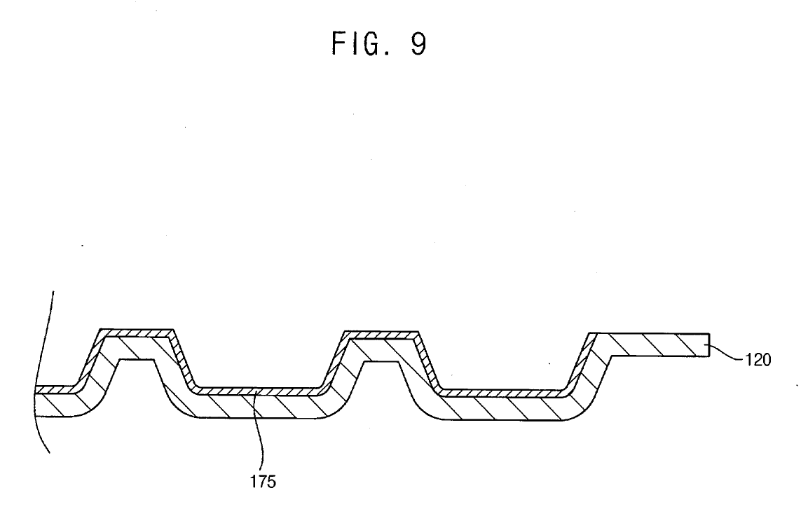

Referring to FIG. 9, a transparent glass plate or sheet is processed to form the second substrate 120. For example, a transparent glass plate may be heated at a temperature higher than a softening point, for example, about 750° C., and compressed air may be applied to a heated glass plate to form the second substrate 120 having a desired shape. A second fluorescent layer 175 is formed on the second substrate 120 having a thickness of about 15 μm. A combining member is affixed to one of the first and the second substrate 110 and 120, to correspond to the sealing portion 126 illustrated in FIG. 3. The combining member is melted by an externally provided heat source and is subsequently cooled to combine the first substrate 110 with the second substrate 120. The above-mentioned combining process may be performed at a temperature of from about 400° C. to about 600° C.

Referring to FIG. 6, the first protective layer 190 may be formed between the reflective layer 160 and the first fluorescent layer 170. The first protective layer 190 prevents mercury vapor in the discharge chamber 130 from penetrating into the first substrate 110 to prevent loss of mercury vapor and blackening of the first substrate 110. For example, the first protective layer 190 may include yttrium oxide (Y₂O₃), and a thickness of the first protective layer 190 may be from about 1 μm to about 2 μm.

Furthermore, the second protective layer 195 may be formed between the second substrate 120 and the second fluorescent layer 175. The second protective layer 195 prevents mercury vapor in the discharge chamber 130 from penetrating into the second substrate 120 to prevent loss of mercury vapor and blackening of the second substrate 120. For example, the second protective layer 195 may include yttrium oxide (Y₂O₃), and a thickness of the second protective layer 195 may be about 1 μm to about 2 μm.

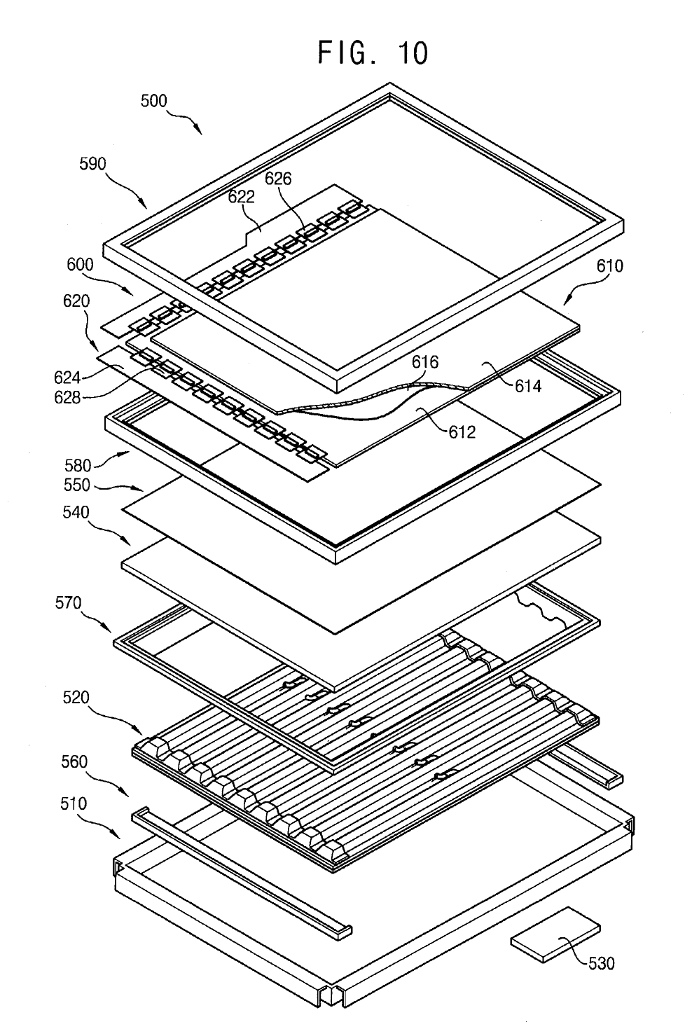

FIG. 10 is an exploded perspective view illustrating an exemplary display apparatus, according to an embodiment of the present invention. Referring to FIG. 10, a display apparatus 500 includes a flat fluorescent lamp 520 for generating light and a display unit 600 for displaying an image by using the generated light. The flat fluorescent lamp 520 generates light in response to a discharge voltage applied to the flat fluorescent lamp 520 from an inverter 530. The flat fluorescent lamp 520 is substantially the same as the flat fluorescent lamp illustrated in FIGS. 1 to 6. Thus, any further description will be omitted.

The display unit 600 includes a display panel 610 substantially displaying an image and a driving circuit part 620 to operate the display panel 610. The display panel 610 includes a first substrate 612, a second substrate 614 combined with and facing the first substrate 612, and a liquid crystal layer 616 between the first substrate 612 and the second substrate 614. The first substrate 612 includes a plurality of thin-film transistors (TFT) arranged in a matrix configuration. The second substrate 614 includes a plurality of red, green and blue color filters having a thin-film shape. The driving circuit part 620 includes a data printed circuit board (PCB) 622 applying a data signal to the display panel 610, a gate PCB 624 applying a gate signal to the display panel 610, a data driving circuit film 626 electrically connecting the data PCB 622 to the display panel 610 and a gate driving circuit film 628 electrically connecting the gate PCB 624 to the display panel 610. Each of the data and gate driving circuit films 626 and 628 includes a tape carrier package (TCP) or a chip-on-film (COF). In one alternative, a signal line may be formed at the gate driving circuit film 628 to omit the gate PCB 624.

The flat fluorescent lamp 520 may be placed in a receiving container 510. The flat fluorescent lamp 520 may be insulated from the receiving container 510, including metal portions, by a buffering member 560. The buffering member 560 may be disposed on the periphery of the flat fluorescent lamp 520 and the buffering member 560 may include an elastic material to absorb external impacts to the flat fluorescent lamp 520. The display apparatus 500 may further include a diffusing plate 540 disposed on the flat fluorescent lamp 520 and at least one optical sheet 550 disposed on the diffusing plate 540. The diffusing plate 540 diffuses light exiting from the flat fluorescent lamp 520 to improve luminescence uniformity. The optical sheet 550 changes the path of the diffused light to improve luminescence characteristics. Examples of the optical sheet 550 may include a diffusing sheet, a condensing sheet, etc.

The display apparatus 500 may further include a first mold 570 and a second mold 580. The first mold secures a peripheral portion of the flat fluorescent lamp 520 and supports a peripheral portion of the diffusing plate 540. The second mold 580 secures edge portions of the diffusing plate 540 and the optical sheet 550 and supports the display panel 610. The display apparatus 500 may further include a top chassis 590 to secure the display unit 600. For example, the top chassis 590 may be composed of a metal having relatively low deformation and relatively high strength characteristics. According to one or more of the above embodiments, mercury vapor in a flat fluorescent lamp may be prevented from migrating due to a temperature difference between discharge chambers, and luminescence characteristics of a flat fluorescent lamp may be improved.

Although the example embodiments of the present invention have been described, it is understood that the present invention should not be limited to these example embodiments but various changes and modifications can be made by one ordinary skilled in the art within the spirit and scope of the present invention as hereinafter claimed.

What is claimed is:

1. A flat fluorescent lamp, comprising:
a first substrate;
a second substrate combined with the first substrate to form a plurality of discharge chambers spaced apart from each other;
a first fluorescent layer formed on an inner surface of the first substrate;
a second fluorescent layer formed on an inner surface of the second substrate;
a combining member disposed between the first substrate and the second substrate to combine the first substrate with the second substrate; and
a contacting layer formed between the first substrate and the second substrate and between the discharge chambers.

2. The flat fluorescent lamp of claim 1, wherein the second substrate comprises:
a plurality of discharge portions spaced apart from the first substrate to form the discharge chambers;
a plurality of non-discharge portions making contact with the contacting layer, each of the non-discharge portions being disposed between the discharge portions; and
a sealing portion that is disposed in a peripheral area of the second substrate and is combined with the first substrate.

3. The flat fluorescent lamp of claim 2, wherein the contacting layer corresponds to the non-discharge portion.

4. The flat fluorescent lamp of claim 3, wherein the contacting layer comprises at least one of yttrium oxide or aluminum oxide.

5. The flat fluorescent lamp of claim 2, wherein the combining member corresponds to the sealing portion.

6. The flat fluorescent lamp of claim 5, further comprising a reflective layer formed between the first substrate and the first fluorescent layer,
wherein a sum of thicknesses of the reflective layer, the first fluorescent layer, the second fluorescent layer and the contacting layer is substantially equal to a thickness of the combining member.

7. The flat fluorescent lamp of claim 5, further comprising:
a reflective layer formed on an inner surface of the first substrate;
a first protective layer formed between the reflective layer and the first fluorescent layer; and
a second protective layer formed between the second substrate and the second fluorescent layer,
wherein a sum of thicknesses of the reflective layer, the first protective layer, the first fluorescent layer, the second protective layer, the second fluorescent layer and the contacting layer is substantially equal to a thickness of the combining member.

8. The flat fluorescent lamp of claim 2, wherein the second substrate further comprises an exhaust portion formed at the non-discharge portion to connect the discharge chambers with each other.

9. The flat fluorescent lamp of claim 1, further comprising an external electrode that is disposed at an outer surface of at least one of the first and the second substrates and spans the discharge chambers.

10. A method of manufacturing a flat fluorescent lamp, the method comprising:
sequentially forming a reflective layer and a first fluorescent layer on an inner surface of a first substrate;
forming a second substrate combined with the first substrate to form a plurality of discharge chambers spaced apart from each other;
forming a second fluorescent layer on an inner surface of the second substrate;
forming a contacting layer on one of the first fluorescent layer and the second fluorescent layer, the contacting layer being disposed between the discharge chambers; and
combining the first substrate with the second substrate.

11. The method of claim 10, wherein the second substrate comprises:
a plurality of discharge portions spaced apart from the first substrate to form the discharge chambers;
a plurality of non-discharge portions making contact with the contacting layer, each of the non-discharge portions being disposed between the discharge portions; and
a sealing portion that is disposed in a peripheral area of the second substrate and is combined with the first substrate,
wherein the contacting layer corresponds to the non-discharge portion.

12. The method of claim 11, wherein the forming the contacting layer comprises:
disposing a mask having an opening that corresponds to the non-discharge portion; and
spray-coating a layer-forming material on one of the first fluorescent layer and the second fluorescent layer to form the contacting layer.

13. The method of claim 11, wherein the contacting layer comprises at least one of yttrium oxide or aluminum oxide.

14. The method of claim 11, further comprising forming a combining member at one of the first substrate and the second substrate, the combining member corresponding to the sealing portion.

15. The method of claim 14, wherein a sum of thicknesses of the reflective layer, the first fluorescent layer, the second fluorescent layer and the contacting layer is substantially equal to a thickness of the combining member.

16. The method of claim 14, further comprising:
forming a first protective layer between the reflective layer and the first fluorescent layer; and
forming a second protective layer between the second substrate and the second fluorescent layer,
wherein a sum of thicknesses of the reflective layer, the first protective layer, the first fluorescent layer, the second protective layer, the second fluorescent layer and the contacting layer is substantially equal to a thickness of the combining member.

17. A display apparatus, comprising:
a flat fluorescent lamp configured to generate light, the flat fluorescent lamp comprising:
a first substrate having a reflective layer and a first fluorescent layer;
a second substrate having a second fluorescent layer, the second substrate being combined with the first substrate to form a plurality of discharge chambers spaced apart from each other;
a combining member disposed between the first substrate and the second substrate to combine the first substrate with the second substrate; and
a contacting layer formed between the first substrate and the second substrate and between the discharge chambers, such that a sum of thicknesses of the reflective layer, the first fluorescent layer, the second fluorescent layer and the contacting layer is substantially equal to a thickness of the combining member; and
a display unit operatively coupled to the flat fluorescent lamp and configured to display an image using the generated light.

18. The display apparatus of claim 17, wherein the flat fluorescent lamp further comprises:
a first protective layer formed between the reflective layer and the first fluorescent layer; and
a second protective layer formed between the second substrate and the second fluorescent layer,
wherein a sum of thicknesses of the reflective layer, the first protective layer, the first fluorescent layer, the second protective layer, the second fluorescent layer and the contacting layer is substantially equal to a thickness of the combining member.
